(19) United States
(12) Patent Application Publication
(10) Pub. No.: US 2011/0234829 A1
(43) Pub. Date: Sep. 29, 2011

(54) METHODS, SYSTEMS AND APPARATUS TO CONFIGURE AN IMAGING DEVICE

(76) Inventors: Nikhil Gagvani, Sterling, VA (US); Steven Bryant, Sterling, VA (US)

(21) Appl. No.: 12/898,918

(22) Filed: Oct. 6, 2010

Related U.S. Application Data
(60) Provisional application No. 61/249,106, filed on Oct. 6, 2009.

(51) Int. Cl. H04N 5/228

(52) U.S. Cl. 348/222.1; 348/E05.031

(57) ABSTRACT

In some embodiments, a non-transitory processor-readable medium stores code representing instructions to cause a processor to receive a first image of a visual pattern from a sensor. The visual pattern encodes at least one compression parameter, at least one capture parameter or at least one video analytic parameter to be applied to the sensor. The code represents instructions to cause the processor to apply the at least one compression parameter, the at least one capture parameter or the at least one video analytic parameter to the sensor. The code further represents instructions to cause the processor to receive a second image from the sensor. The sensor captures or analyzes the second image according to the at least one compression parameter, the at least one capture parameter or the at least one video analytic parameter.

### CROSS-REFERENCE TO RELATED APPLICATION

This application claims priority to U.S. Provisional Patent Application No. 61/249,106, filed Oct. 6, 2009, entitled “Method, System and Apparatus to Set Up a Digital Camera,” which is incorporated herein by reference in its entirety.

### BACKGROUND

Some embodiments described herein relate generally to methods, systems and apparatus for configuring digital imaging devices, and more particularly to applying settings to a security camera.

Known methods for configuring a wireless device to connect with a wireless network include inputting data associated with the wireless network via a controller directly coupled to the wireless device. For example, a user can use a keyboard connected to an external communication port of the wireless device to provide settings of a wireless network, such as an SSID, a WEP key, a WPA key and/or the like. Based on the provided settings, the wireless device can wirelessly connect to a specified network. Similarly, known methods for configuring compression parameters, capture parameters and/or video analytic parameters of an imaging device include inputting data associated with the compression parameters, capture parameters and/or video analytic parameters via a controller directly coupled to the imaging device via an external communication port.

Devices without external communication ports to which a user can connect an Ethernet cable, a keyboard, a mouse and/or other input device, can be difficult to configure. More specifically, such known methods are inadequate to configure wireless imaging devices not having external communication ports. Thus, a need exists for methods, systems and apparatus to configure an imaging device without external communication ports.

### SUMMARY OF THE INVENTION

In some embodiments, a non-transitory processor-readable medium stores code representing instructions to cause a processor to receive a first image of a visual pattern from a sensor. The visual pattern encodes at least one compression parameter, at least one capture parameter or at least one video analytic parameter to be applied to the sensor. The code represents instructions to cause the processor to apply the at least one compression parameter, the at least one capture parameter or the at least one video analytic parameter to the sensor. The code further represents instructions to cause the processor to receive a second image from the sensor. The sensor captures or analyzes the second image according to the at least one compression parameter, the at least one capture parameter or the at least one video analytic parameter.

### BRIEF DESCRIPTION OF THE DRAWINGS

FIG. 1 is a schematic diagram that illustrates an imaging device in communication with a host device via a network, according to an embodiment.

FIG. 2 is a schematic diagram of a processor of the imaging device of FIG. 1.

FIG. 3 is an illustration of a form used to define a visual pattern, according to another embodiment.

FIG. 4 is an illustration of a sequence of visual patterns, according to another embodiment.

FIG. 5 is a flow chart illustrating a method of applying settings encoded in a visual pattern to an imaging device, according to another embodiment.

### DETAILED DESCRIPTION

In some embodiments, a non-transitory processor-readable medium stores code representing instructions to cause a processor to receive a first image of a visual pattern from a sensor. The visual pattern encodes at least one compression parameter, at least one capture parameter or at least one video analytic parameter to be applied to the sensor. The code represents instructions to cause the processor to apply the at least one compression parameter, the at least one capture parameter or the at least one video analytic parameter to the sensor. The code further represents instructions to cause the processor to receive a second image from the sensor. The sensor captures or analyzes the second image according to the at least one compression parameter, the at least one capture parameter or the at least one video analytic parameter.

In such embodiments, the sensor of an imaging device is used as an input. More specifically, in such embodiments, a user of the imaging device can present the visual pattern, encoding one or more parameters, to the sensor. The sensor can capture an image of the visual pattern and the imaging device can decode the visual pattern to determine the parameters encoded by the visual pattern. The settings encoded can then be applied to the imaging device.

In some embodiments, a non-transitory processor-readable medium stores code representing instructions to cause a processor to receive a first image of at least one visual pattern from a sensor. The at least one visual pattern encodes an identifier of a user and at least one compression parameter, at least one capture parameter or at least one video analytic parameter to be applied to the sensor. The code represents instructions to cause the processor to verify that the user is authorized to configure the sensor based on the identifier of the user and to apply the at least one compression parameter, the at least one capture parameter or the at least one video analytic parameter to the sensor. The code further represents instructions to cause the processor to receive a second image from the sensor. The sensor captures or analyzes the second image according to the at least one compression parameter, the at least one capture parameter or the at least one video analytic parameter.

In some embodiments, an apparatus includes an imaging device configured to capture an image of at least one encrypted visual pattern encoding a secure identifier of a user, an identifier of the imaging device, and at least one setting to be applied to the imaging device. The imaging device is configured to decrypt the visual pattern using a key stored at the imaging device. The imaging device is configured to verify that the user is authorized to modify the at least one setting based on the secure identifier of the user and the identifier of the imaging device. The imaging device is configured to apply the at least one setting if the user is authorized to modify the at least one setting.

As used in this specification, the singular forms “a,” “an” and “the” include plural referents unless the context clearly dictates otherwise. Thus, for example, the term “a module” is intended to mean a single module or a combination of modules.

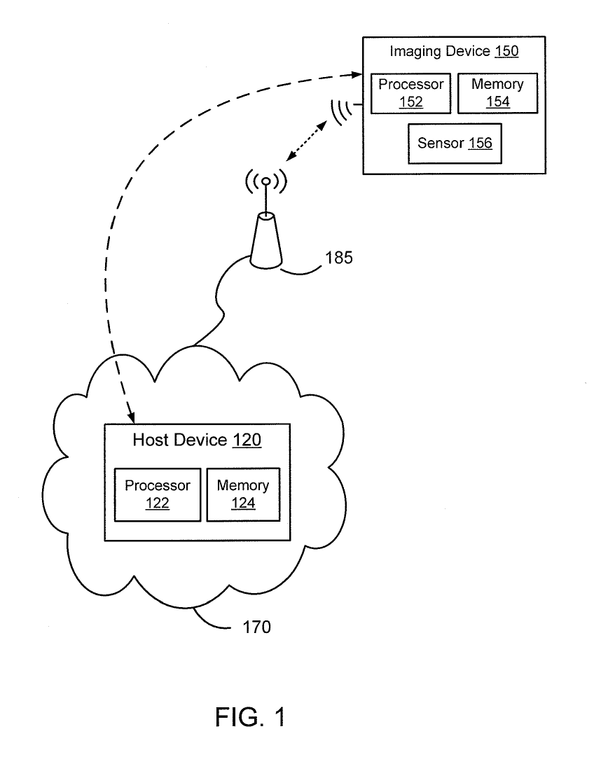

FIG. 1 is a schematic diagram that illustrates an imaging device 150 in communication with a host device 120 via a network 170, according to an embodiment. Specifically, imaging device 150 is configured to communicate wirelessly with the host device 120 via a gateway device 185. The network 170 can be any type of network (e.g., a local area network (LAN), a wide area network (WAN), a virtual network, a telecommunications network) implemented as a wireless network. In other embodiments, the imaging device 150 communicates wirelessly with the host device using a cellular network, Wimax, Zigbee, Bluetooth, a Global System for Mobile Communications (GSM) network, a network using code division multiple access (CDMA) or wideband CDMA (WCDMA), or the like.

The imaging device 150 can be, for example, a security camera to capture still and/or video images of an area and/or scene. Additionally, in some embodiments, the imaging device 150 can be configured to perform video analytics on an image captured by the imaging device 150. In such embodiments, for example, the imaging device 150 can automatically detect events of interest by analyzing video. For example, the imaging device 150 can detect motion, a person and/or persons, vehicles, and/or the like. In such embodiments, the imaging device 150 can include the capability to differentiate a person from other moving objects, such as a vehicle.

In some embodiments, the imaging device can detect events defined by a set of rules and/or criteria. For example, the imaging device can detect a person in a zone, and/or a person or vehicle crossing a virtual boundary (e.g., an arbitrary curve in the field of view). Additional events can include tracking a unique person or vehicle through the field of view while other objects are present and moving in the field of view, and/or detecting if the same object has been in the field of view or in a marked area and/or zone for a period longer than a predetermined amount of time. In some embodiments, events can also include converging persons, loitering persons, objects left behind and/or objects removed from the view.

The imaging device 150 can capture a still image and/or a video image when an event is detected, and send the still image and/or video image to the host device 120. The host device 120 can then further disseminate the still image and/or video to other recipients (e.g., a security guard). Although not shown, in some embodiments, the imaging device 150 can include one or more network interface devices (e.g., a network interface card) configured to connect the imaging device 150 to the gateway device 185.

As shown in FIG. 1, the imaging device 150 has a processor 152, a memory 154, and a sensor 156. The memory 154 can be, for example, a random access memory (RAM), a memory buffer, a hard drive, and/or so forth. The sensor 156 can be any suitable imaging device, such as, for example, a security camera, a pan-tilt-zoom (PTZ) camera, a charge-coupled device camera, a complementary metal oxide semiconductor (CMOS) sensor, and/or the like. In some embodiments, the sensor 156 is an optical sensor, an electrical sensor or an opto-electrical sensor. As such, the sensor 156 can include optical components and/or electrical components configured to process incident light into electrical signals.

While shown in FIG. 1 as being separate components, in some embodiments, the processor 152, memory 154 and sensor 156 can be included on a single chip and/or chip package. For example, the processor 152, memory 154 and sensor 156 can be included on a single system-on-chip (SoC) package. Accordingly, processing functions (including the modules of the processor 152 shown and described herein) can be executed on the same chip package as the sensor 156.

In some embodiments, the imaging device 150 does not include external communication ports, such as, for example, universal serial bus (USB) ports, parallel ports, serial ports, optical ports, Ethernet ports, compact disc drives, PS/2 ports, and/or the like. As such, external wires and/or cables are not coupled to the imaging device and are not used to connect the imaging device 150 to a compute device (e.g., a personal computer, a personal digital assistant (PDA), a mobile telephone, a router, etc.) or an input device (e.g., a mouse, a keyboard, a touch-screen display, etc.). In such embodiments, and as described in further detail herein, the sensor 156 can be used as an input. For example, visual patterns encoding one or more network connection setting (e.g., a service set identifier (SSID) of a network, a passkey of a network, a wired equivalent privacy (WEP) key of a network, a Wi-Fi protected access (WPA) key of a network, etc.), one or more compression parameters (e.g., a bitrate parameter, an image quality parameter, an image resolution parameter, or a frame rate parameter, etc.), one or more capture parameters (e.g., an exposure mode, a shutter speed, a white balance parameter, or an auto-focus parameter, etc.) and/or one or more video analytic parameters (e.g., send an indicator when a person is detected, send an indicator when converging persons are detected, send an indicator when a vehicle is detected, etc.) can be presented to the sensor 156. After the visual pattern is received by the sensor, the processor 152 of the imaging device can apply such settings and/or parameters to the imaging device 150, as described in further detail herein.

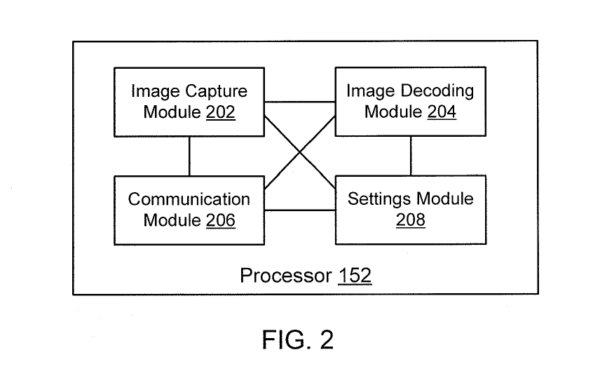

FIG. 2 illustrates the processor 152 of the imaging device 150. The processor 152, includes an image capture module 202, an image decoding module 204, a communication module 206 and a settings module 208. While each module is shown in FIG. 2 as being in direct communication with every other module, in other embodiments, each module need not be in direct communication with every other module.

The image capture module 202 is configured to interface with the sensor 156. More specifically, the image capture module 202 is configured to instruct the sensor 156 to capture an image (e.g., a still image and/or a video image) of a scene. Additionally, the image capture module 202 can apply compression parameters, capture parameters and/or video analytic parameters to the sensor 156. The image capture module 202 can also be configured to receive captured images of the scene from the sensor 156.

The communication module 206 is configured to facilitate communication between the imaging device 150 and the network 170. This allows the imaging device 150 to send data to and/or receive data from the host device 120. For example, the communication module 206 can receive setting information from the host device 120 and send the captured images to the host device 120, as described in further detail herein.

The image decoding module 204 is configured to decode visual patterns captured by the sensor 156. As described in further detail herein, in some embodiments, such visual patterns can be used to apply network connection settings to the camera (e.g., an SSID of a network, a passkey of a network, a WEP key of a network, a WPA key of a network, etc.). In other embodiments, such visual patterns can be used to apply one or more compression parameters (e.g., a bitrate parameter, an image quality parameter, a resolution parameter, or a frame rate parameter, etc.), one or more capture parameters (e.g., an exposure mode, a shutter speed, a white balance parameter, or an auto-focus parameter, etc.) and/or one or more video analytic parameters (e.g., send indicator when a person is detected, send indicator when converging persons are detected, send indicator when a vehicle is detected, etc.) to the imaging device 150. In some embodiments, such visual patterns can include high capacity color barcodes, quick response (QR) codes, one-dimensional barcodes, and/or the like.

The settings module 208 is configured to receive instructions from the image decoding module 204 to update settings (e.g., network connection settings, compression parameters, capture parameters, video analytic parameters, etc.). For example, after the image decoding module 204 decodes a visual pattern, the image decoding module can instruct the settings module 208 to apply the new settings. The settings module 208 can then send newly applied compression parameters, capture parameters, and/or video analytic parameters to the image capture module 202 and/or newly applied network connection settings to the communication module 206.

While not shown in FIG. 2, in some embodiments, the processor 152 includes a video analysis module. Such a video analysis module can be configured to receive an image from the image capture module 202 and perform video analytics on the image. A such, the video analysis module can detect and/or track objects and/or groups of objects in the sensor's 156 field of view. For example, the video analysis module can be used to track a person, a vehicle, converging persons, converging vehicles, a loitering person, an abandoned vehicle, and/or the like.

Returning to FIG. 1, the host device 120 can be any type of device configured to send data over the network 170 to and/or receive data from one or more imaging devices 150. In some embodiments, the host device 120 can be configured to function as, for example, a server device (e.g., a web server device), a network management device, and/or so forth.

The host device 120 includes a memory 124 and a processor 122. The memory 124 can be, for example, a random access memory (RAM), a memory buffer, a hard drive, a database, and/or so forth. In some embodiments, the host device 120 stores images and/or data associated with images received from the imaging device 150 via the network 170.

In some embodiments, multiple imaging devices 150 may communicate with a single host device 120. In such embodiments, the host device 120 can function as a server for the imaging devices 150. For example, the host device 120 can function as a web server and/or a database server. Such a web server can host one or more web applications that users can access using a client device to view event images or event clips received from the imaging devices 150. Such a web server can also host applications that can be used to set up the preferences and/or settings for a camera including compression parameters, capture parameters and/or video analytic parameters. A database server can be used to store preferences corresponding to multiple end-user accounts and/or imaging devices 150. Such preferences for the imaging devices 150 can be automatically sent (e.g., pushed) over the network 170 to each respective imaging device 150.

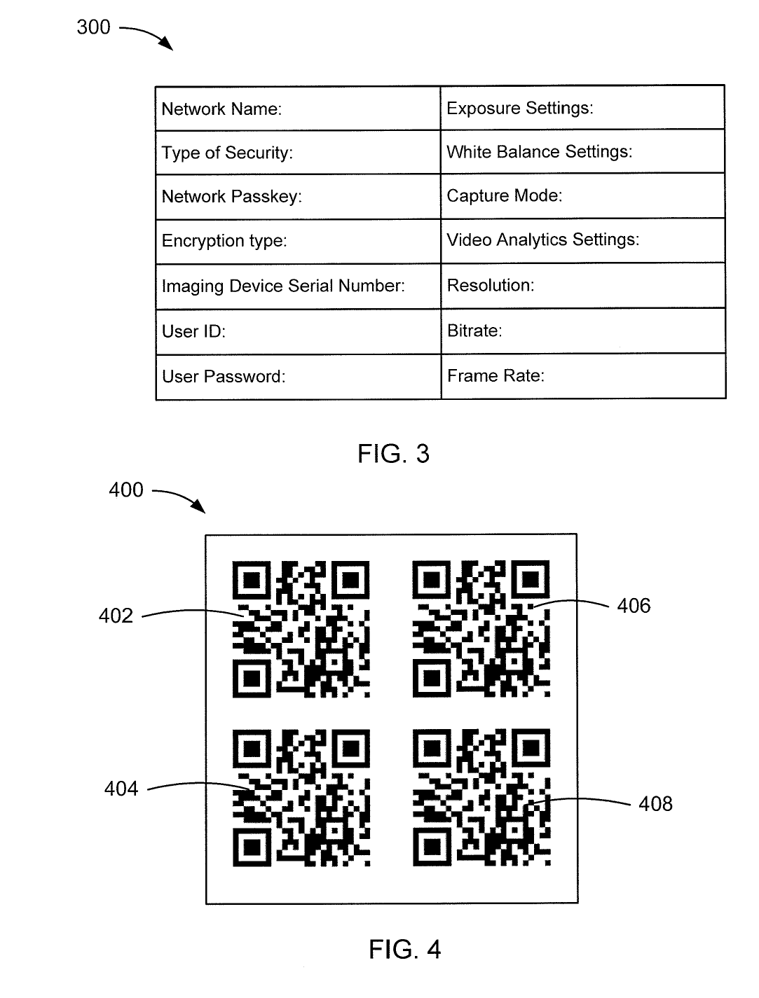

In use, a user supplies power to the imaging device 150 and accesses a web server (not shown) from a communication device (not shown). Such a communication device can be, for example, a computing entity such as a personal computing device (e.g., a desktop computer, a laptop computer, etc.), a mobile phone, a monitoring device, a personal digital assistant (PDA), and/or the like. The web server can provide the user a form such as the form 300 shown in FIG. 3.

The form 300 allows a user to enter values for one or more settings and/or parameters. For example, the user can enter values for one or more network connection settings (e.g., an SSID of a network, a passkey of a network, a WEP key of a network, a WPA key of a network, etc.), one or more compression parameters (e.g., a bitrate parameter, an image quality parameter, an image resolution parameter, or an image frame rate parameter, etc.), one or more capture parameters (e.g., an exposure mode, a shutter speed, a white balance parameter, or an auto-focus parameter, etc.) and/or one or more video analytic parameters (e.g., send an indicator when a person is detected, send an indicator when converging persons are detected, send an indicator when a vehicle is detected, etc.). Additionally, the user can enter a serial number of the imaging device 150 (or other identifier that uniquely identifies the imaging device 150), a user identifier associated with the user, and/or a password associated with the user.

The web server can process and/or encrypt the information provided by the user. In some embodiments, for example, a private key uniquely available to the web server can be used to encrypt the information provided by the user (e.g., the network connection settings, the compression parameters, the capture parameters, the video analytic parameters, the identifier of the imaging device 150, the user identifier and/or password associated with the user, and/or the like). In some embodiments, the unique serial number of the imaging device 150 and/or another identifier of the imaging device 150 can be used by the encryption scheme as an input to a hash function to uniquely tag and/or identify the data prior to encryption.

The encrypted data can then converted into one or more a visual patterns, such as a QR Code. FIG. 4 illustrates an example of a series of QR Codes 400 encoding configuration data provided by the user. In other embodiments, any other identifier can be used, such as, for example, high capacity color barcodes, one-dimensional barcodes, and/or the like.

In some embodiments, the user can print the visual pattern and present the visual pattern to the sensor 156. Alternately, the user can place the sensor 156 in front of a display (e.g., a cathode ray tube (CRT) display, a liquid crystal display (LCD), a Plasma display, an organic light emitting diode (OLED) matrix display device, etc.) of a device displaying the visual pattern. In some embodiments, such a visual pattern can be static (e.g., a still image) or dynamic (e.g., a changing image, such as a video image), and can be a single image or a sequence of images. The sensor 156 on the imaging device 150 is preconfigured (e.g., configured during manufacture) to read such visual patterns. The image and/or sequence of images is processed by the imaging device 150 and the visual pattern is decoded to extract the encrypted configuration data. More specifically, the image capture module 202 receives the image of the visual pattern and sends the image to the image decoding module 204 to decode the visual pattern.

The image decoding module 204 decrypts the configuration data. In some embodiments, an embedded public key (paired to a private key used to encrypt the configuration data) is used to decrypt the configuration data. The image decoding module 204 can extract the serial number, user identifier and/or user password from the configuration data. If the serial number supplied by the user matches the serial number hardcoded at the imaging device 150 and if the user identifier and password match an authorized user, the image decoding module 204 sends the configuration data to the settings module to store and apply the settings. If the serial number supplied by the user does not match the serial number hardcoded at the imaging device 150 and/or if the user identifier and/or password do not match those of an authorized user, the configuration data can be discarded.

In some embodiments, the imaging device 150 can include one or more indicators such as, for example, light emitting diodes (LEDs) and/or a speaker. A first indication (e.g., a confirmation signal) can be provided (e.g., lighting an LED and/or causing the speaker to produce an audible tone) if the settings were successfully applied, while a second indication (e.g., an error signal) can be provided if there was an error in applying the settings (e.g., serial numbers did not match, unauthorized user, etc.).

For example, if the configuration data supplied by the user includes network connection parameters, the settings module 208 sends the network connection parameters to the communication module 206. The communication module 206 can use the connection parameters to configure the imaging device 150 to connect to the network 170 associated with the network connection parameters. For example, if an SSID and a WEP key is supplied by the user (e.g., using a visual pattern generated from the form 300 of FIG. 3), the communication module 106 can configure the imaging device 150 (e.g., a network interface card of the imaging device 150) to communicate across the network identified by that SSID.

In some embodiments, this initiates a chain of trust between the web server and the user. In such embodiments, the user can be authorized at the web server using the user name, password and/or any other secure method, such as a credit card, a bank account, a digital certificate, and/or the like. The imaging device's 150 unique identifier can be associated with the user's account on the web server. The public-private key combination and the embedded unique identifier in the pattern can be used to ensure that a) only the authorized user can generate a valid configuration pattern for that imaging device 150, and b) the imaging device 150 can verify that it is the imaging device to which the configuration is directed (e.g., using the imaging device's 150 serial number).

In some embodiments, the association between a user and an imaging device can be defined the first time a user logs into a web server and successfully registers a imaging device 150. In some embodiments, subsequent to the initial login, that user can uniquely be permitted to make future configuration changes to that imaging device 150. This ensures that unauthorized users do not change the configurations of the imaging device 150. In some embodiments, when a user successfully registers an imaging device, a confirmation message can be transmitted to the web server, which presents a confirmation of the network connection and/or the user's information to the user (e.g., either at a communication device connected to the network and/or via a visual (e.g., using an LED) and/or audio (e.g., using a speaker) indicator at the imaging device 150).

In other embodiments, an application stored and running locally on a communication device having a display can be used to generate the visual pattern (e.g., instead of a web server). Such an application can be used if the user cannot access the web server. In such embodiments, the user can enter configuration information (e.g., network connection settings, compression parameters, capture parameters, video analytic parameters, etc.) for the camera into the application. The application can encrypt the configuration information and encode the configuration information into a visual pattern (or sequence of visual patterns). In some embodiments, the visual pattern can then be displayed on the display of the communication device. The user can then present the visual pattern (as displayed on the display) to the sensor 156 of the imaging device 150 to configure the imaging device 150, as described above. In some embodiments, such a display can be a cathode ray tube (CRT) display, a liquid crystal display (LCD), a Plasma display or an organic light emitting diode (OLED) matrix display device.

In some embodiments, the visual pattern can be placed in front of the sensor 156 in a relatively unconstrained manner with no structured illumination from the imaging device 150. For example, the imaging device 150 need not project light on the visual pattern to read the visual pattern. Additionally, in some embodiments, the visual pattern need not be placed a specified distance from the sensor 156 for the sensor 156 to read the visual pattern. For example, in such embodiments, the distance between the sensor 156 and the visual pattern may range from a few inches to greater than 10 feet.

In some embodiments, the orientation of the visual pattern need not be perpendicular to the camera sensor. In such embodiments, the visual pattern can be arbitrarily rotated within a plane of the sensor 156 and/or tilted out of the plane of the sensor. The imaging device 150 can be configured to rectify and rotate the image automatically, and to define a fixed scale or resolution version of the visual pattern for analysis.

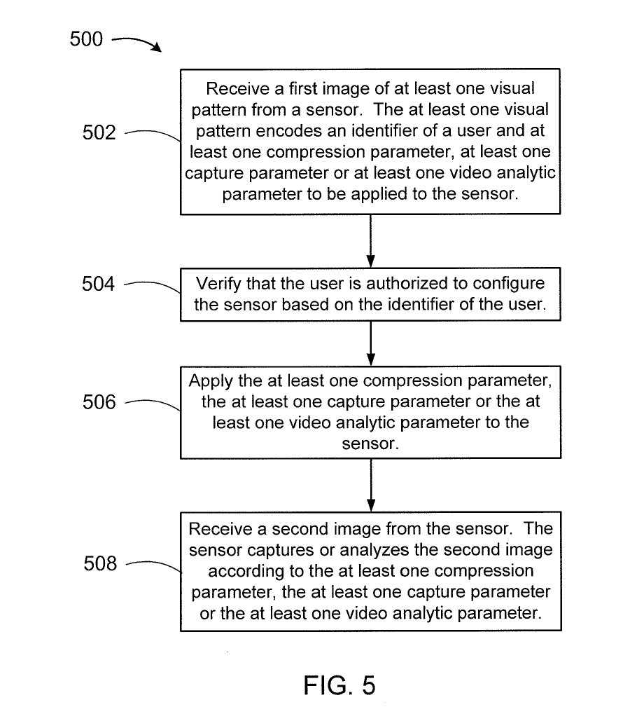

FIG. 5 is a flow chart illustrating a method 500 of applying settings encoded in a configuration identifier to an imaging device, according to another embodiment. The method 500 includes receiving a first image of at least one visual pattern from a sensor, at 502. The at least one visual pattern encodes an identifier of a user and at least one compression parameter, at least one capture parameter or at least one video analytic parameter to be applied to the sensor. As discussed above, the at least one compression parameter can include at least one of a bitrate parameter, an image quality parameter, an image resolution parameter or a frame rate parameter, and the at least one capture parameter can include at least one of an exposure mode, a shutter speed, a white balance parameter, or an auto-focus parameter. The at least one video analytic parameter can include a setting that instructs the imaging device to detect one or more events (e.g., a person, converging persons, a vehicle, converging vehicles, loitering person, abandoned vehicle, etc.). In some embodiments, the at least one video analytic parameter can also instruct the imaging device to send an indicator (e.g., an alarm, a text message, etc.) when an event is detected. In some embodiments, the visual pattern can include one or more high capacity barcodes, QR Codes, or one-dimensional barcodes. In other embodiments the visual pattern includes a sequence of visual patterns, a time-varying pattern, and/or is a video containing visual patterns. The visual pattern can include of binary states (e.g., black and white or bi-color data) or it may include an arbitrary number of colors and intensities to produce any number of states.

The method includes verifying that the user is authorized to configure the sensor based on the identifier of the user, at 504. The identifier of the user can include a user name and/or password of an authorized user for the sensor. As such, if the user name and/or password can be verified for the sensor, the provided compression parameter or the provided capture parameter can be applied. If, however, the user name and/or password does not match an authorized user of that imaging device, than the provided compression parameter or the provided capture parameter are not applied. Accordingly, unauthorized users cannot reconfigure the sensor.

The at least one compression parameter, the at least one capture parameter or the at least one video analytic parameter is applied to the sensor, at 506. A second image is received from the sensor, at 508. The sensor captures the second image according to the at least one compression parameter or the at least one capture parameter. In some embodiments, the second image is of the scene to be monitored by the imaging device.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

In some embodiments, security credentials, such as a certificate, can be generated by a trusted third-party server, which is accessible to both the imaging device and a pattern generation application. The pattern generation application encodes the security certificate into the visual pattern. When this visual pattern is read and decoded by the imaging device, the imaging device can verify the certificate with the certificate provider before it applies the settings. This can ensure that an unauthorized user does not change the settings.

While shown and described above as being encoded into a single visual pattern, in some embodiments, the configuration settings to be applied at an imaging device can be encoded into a series of visual patterns. For example, such settings can result in an amount of configuration data, which when coded into computer readable form as a visual pattern, can exceed the amount of information that can be coded into a single visual pattern. Multiple pages and/or a sequence of visual patterns can be used to provide a large number of settings and/or a large amount of data to the imaging device. A visual pattern protocol, where a sequence of images or visual patterns is transmitted can be used in this case. Such a visual pattern protocol can include specifically coded information, for example, a header, a sequence number and a continuation flag. The header in the pattern can specify contextual information about the data and can include, for example, a number of pages, a duration for which each pattern is presented, an offset to each section of configuration information (e.g., an offset between compression settings, video analytic parameters, network configuration settings, etc.). The sequence number can be used to re-order the patterns if presented out of order by the user. The continuation flag can be used to indicate that additional pages follow. Additionally, the continuation flag can be set to indicate the last pattern in the transmission. Using such a visual pattern protocol can allow a user to provide large amounts of data to the imaging device.

In some embodiments, a display to be presented to a sensor can include light emitting diodes (LEDs) or other illuminators that can be turned on or off in a pattern. The display can produce illumination in a visual pattern (e.g., in the visible part of the electromagnetic spectrum) to be read by the sensor of the imaging device. In still other embodiments, such LEDs or illuminators can produce illumination in the ultra-violet (UV) or infrared portion of the electromagnetic spectrum. For example, in such embodiments, an imaging device can include a sensor that is selectively sensitive to a specific set of emitted electromagnetic wavelengths such as wavelengths emitted from an infrared source such as a pattern of infrared LEDs. A pattern of wavelengths can be used to encode the configuration information. Accordingly, such an infrared pattern can be used to transmit configuration information to the imaging device. For example, by varying the intensity of the LEDs over time, the infrared pattern can encode and transmit the configuration information.

In some embodiments, the visual patterns can be full-motion video that encodes information in specific areas of the video image. For example, the sensor of the imaging device can be configured to receive configuration information from the video image at certain portions of the video image. In such embodiments, for example, when a device displaying the video image is presented to the sensor, the sensor can capture the video image and decode the configuration information encoded in the video image. In other embodiments, any other suitable method, such as, for example, steganography can be used to encode and convey configuration information to the imaging device.

In some embodiments, an imaging device can include a character recognition module configured to recognize alphanumeric characters. For example, such a character recognition module can employ optical character recognition (OCR). In such embodiments, a user can present alphanumeric characters corresponding to the values of the imaging device settings to be changed. The sensor can produce an image of the alphanumeric characters and provide the image to the character recognition module. The character recognition module can interpret the image of the alphanumeric characters and update and/or change the settings as appropriate.

In some embodiments, the sensor can capture the pattern under unconstrained and time-varying illumination conditions. For example, if the imaging device is outdoors, the illumination conditions can vary greatly. In such embodiments, if the camera does not have an automatic gain control setting and/or an automatic exposure control enabled, the camera might not be able to sufficiently capture the visual pattern. Accordingly, in some embodiments, a portion of a visual pattern can include settings that are not encrypted. This allows the imaging device to sufficiently read and apply the settings encoded in at least a portion of the visual pattern, even if the imaging device cannot read the entire visual pattern. This allows the imaging device to optimize its settings to be able to successfully read the remainder of the visual pattern.

In some embodiments, an imaging device includes an input, such as, for example, a button, that a user can press to indicate to the imaging device that the user is presenting a visual pattern having configuration information to the imaging device. In response to the button being pressed, the imaging device can switch from a normal imaging mode to a configuration mode. In the normal imaging mode, the imaging device can be configured to image and/or produce images of a scene in the sensor's field of view. In the configuration mode, the sensor can be configured to image visual patterns presented by a user. Accordingly, a user can press the button prior to presenting a visual pattern to the sensor.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described.

What is claimed is:

1. A non-transitory processor-readable medium storing code representing instructions to cause a processor to:
receive a first image of at least one visual pattern from a sensor, the at least one visual pattern encoding an identifier of a user and at least one compression parameter, at least one capture parameter, or at least one video analytic parameter to be applied to the sensor;
verify that the user is authorized to configure the sensor based on the identifier of the user;
apply the at least one compression parameter, the at least one capture parameter or the at least one video analytic parameter to the sensor; and
receive a second image from the sensor, the sensor capturing or analyzing the second image according to the at least one compression parameter, the at least one capture parameter or the at least one video analytic parameter.

2. The non-transitory processor-readable medium of claim 1, wherein the at least one visual pattern is one of a high capacity color barcode, a QR Code, or a one-dimensional barcode.

3. The non-transitory processor-readable medium of claim 1, wherein the at least one compression parameter includes at least one of a bitrate parameter, an image quality parameter, a resolution parameter, or a frame rate parameter.

4. The non-transitory processor-readable medium of claim 1, wherein the at least one capture parameter includes at least one of an exposure mode, a shutter speed, a white balance parameter, or an auto-focus parameter.

5. The non-transitory processor-readable medium of claim 1, wherein the at least one visual pattern is displayed on a display having a plurality of intensity values, the at least one compression parameter or the at least one capture parameter being at least partially encoded by the plurality of intensity values.

6. The non-transitory processor-readable medium of claim 1, wherein the at least one visual pattern encodes the at least one compression parameter and the at least one video analytic parameter.

7. The non-transitory processor-readable medium of claim 1, wherein the visual pattern is encrypted using a security certificate received from a trusted third-party server.

8. The non-transitory processor-readable medium of claim 1, wherein the identifier of the user includes a user name and a password.

9. An apparatus, comprising:
an imaging device to capture an image of at least one encrypted visual pattern encoding a secure identifier of a user, an identifier of the imaging device and at least one setting to be applied to the imaging device,
the imaging device to decrypt the visual pattern using a key stored at the imaging device,
the imaging device to verify that the user is authorized to modify the at least one setting based on the secure identifier of the user and the identifier of the imaging device,
the imaging device to apply the at least one setting if the user is authorized to modify the at least one setting.

10. The apparatus of claim 9, wherein the secure identifier of the user includes a user name and a password.

11. The apparatus of claim 9, wherein the imaging device does not have external communication ports.

12. The apparatus of claim 9, wherein the at least one setting includes at least one compression parameter or at least one capture parameter.

13. The apparatus of claim 9, wherein the imaging device is to rectify, rotate, orient and scale the at least one visual pattern.

14. The apparatus of claim 9, wherein the at least one encrypted visual pattern encodes at least one video analytic parameter.

15. A non-transitory processor-readable medium storing code representing instructions to cause a processor to:
receive a first video image of a sequence of visual patterns from a sensor, the sequence of visual patterns encoding at least one compression parameter, at least one capture parameter, or at least one video analytic parameter to be applied to the sensor;
apply the at least one compression parameter, the at least one capture parameter or the at least one video analytic parameter to the sensor; and
receive a second video image from the sensor, the sensor capturing or analyzing the second image according to the at least one compression parameter, the at least one capture parameter, or the at least one video analytic parameter.

16. The non-transitory processor-readable medium of claim 15, wherein the at least one compression parameter includes at least one of a bitrate parameter, an image quality parameter, a resolution parameter, or a frame rate parameter.

17. The non-transitory processor-readable medium of claim 15, wherein the at least one capture parameter includes at least one of an exposure mode, a shutter speed, a white balance parameter, or an auto-focus parameter.

18. The non-transitory processor-readable medium of claim 15, wherein the sequence of visual patterns encodes an identifier of a user, the non-transitory processor-readable medium further comprising code representing instructions to cause the processor to:
verify that the user is authorized to configure the sensor based on the identifier of the user.

19. The non-transitory processor-readable medium of claim 15, wherein the sequence of visual patterns encodes the at least one capture parameter and the at least one video analytic parameter.

20. The non-transitory processor-readable medium of claim 15, further comprising code representing instructions to cause the processor to:
transmit the second image via a wireless network.
